(19) United States
(12) Patent Application Publication
(10) Pub. No.: US 2006/0158988 A1
(43) Pub. Date: Jul. 20, 2006

(54) Hologram recording/reproducing device, and recording method, reproduction method and hologram recording medium thereof

(75) Inventor: Akiyoshi Uchida, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/114,726

(22) Filed: Apr. 26, 2005

(30) Foreign Application Priority Data
Jan. 20, 2005 (JP) 2005-012841

(51) Int. Cl. G11B 7/00

(52) U.S. Cl. 369/103; 369/112.01

(57) ABSTRACT

A hologram recording/reproducing device for recording and reproducing information to/from a hologram recording medium adapted to multiplexing and recording of a plurality of page data. The medium includes an address region and a recording region, the medium including a plurality of physical addresses each composed of a first physical address and a second physical address. The recording/reproducing device includes: a recording part; and a reproducing part, the recording part specifying the plurality of physical addresses to write user data into a specific physical address, the recording part writing the second physical address together with the user data in a specific recording unit region specified by the second physical address, the reproducing part reading page data recorded in a designated physical address.

### CROSS REFERENCE TO RELATED APPLICATION

This application is related to Japanese patent application No. 2005-012841 filed on Jan. 20, 2005, whose priority is claimed under 35 USC §119, the disclosure of which is incorporated by reference in its entirety.

### BACKGROUND OF THE INVENTION

1. Field of the Invention

The present invention relates to a hologram recording/reproducing device. In particular, the present, invention relates to a hologram recording/reproducing device in which a structure for recording address information showing a recording position on a hologram recording medium is devised in order to realize high density, and further relates to a recording method, a reproduction method and a hologram recording medium of the hologram recording/reproducing device.

2. Description of the Related Art

As portable media capable of recording information in large volume, magneto-optical recording media and optical disks have conventionally been used. Typical examples of the portable media include a MO, MD, CD-ROM, CD-R, CD-RW, DVD-ROM, DVD-R, DVD-RAM, and DVD-RW. Further, a “hologram recording and reproducing technique” is recently drawing attention as a technique for realizing a recording medium having a higher volume. This is a technique for multiplexing, for recording, a plurality of pieces of information in the same region by means of a hologram.

A hologram recording medium has a lamination structure of a reflection layer, a first transparent substrate, a recording layer including hologram recording materials and a second transparent substrate (e.g., see PCT International Publication No. WO99/44195 pamphlet).

In the hologram recording medium, information is recorded in the following manner. Information light for carrying information and reference light for recording are generated by laser light. The medium is irradiated with these lights from the second transparent substrate side. The reference light for recording and the information light reflected by the reflection layer are laminated in the recording layer. An interference fringe pattern produced by interference of these lights is then written in the recording layer. On the other hand, when the recording layer where the interference fringe pattern has been written is irradiated with illumination light for reproduction from the second transparent substrate side, the light is diffracted by the interference fringe pattern to generate reproduction light. Information is then reproduced based upon the reproduction light having transmitted through the second transparent substrate.

Such a hologram recording medium has two characteristics of page recording and multiplex recording. The “page recording” means that the minimum unit of information to be recorded on a medium is not on the order of one to several bits as in the case of a conventional optical disk, but is one page consisting of multiple bits. In one page, for example, ten-thousand-bit information or one-million-bit information is recorded, and the information is recorded and reproduced in this one-page unit.

Moreover, in the conventional optical disk or magnetic disk, the minimum unit for recording is “pit”. “One pit” corresponds to one-bit data or several-bit data, and is typically recorded on a disk as one-dimensionally arranged information (see FIG. 8).

On the other hand, in the hologram recording medium, one page as the minimum unit includes multiple bits, and a large number of pieces of information are recorded in a two-dimensional region (see FIG. 9).

The “multiplex recording” means that a plurality of pieces of data are overlaid on each other and recorded in the same region. In the conventional optical disk or magnetic disk, only one piece of data can be recorded in one recording region, and there has not been a case where a plurality of pieces of data as the minimum unit for recording are overlaid on each other and recorded in the same region.

In the hologram recording medium, on the other hand, information is recorded as an interference fringe pattern as described above, and hence pieces of two-dimensional page data can be overlaid on each other and recorded in the same region as shown in FIG. 9.

Such a conventional medium has a region (data region) for recording data produced by a user, and a region for recording address information for specifying a recording position on the medium. A desired data region is specified by detection of the address information to thereby record or reproduce data.

Further, a minimum unit region for recording and reproducing user data in physical terms is called a “sector”, and a physical address is allocated to each sector. The physical address generally forms a concavo-convex pit or a wobble pattern on a medium and is formed as a pre-pit in advance.

The address information other than the information specifying a physical recording position may include servo information for performing focus servo and tracking servo, and information for synchronization. These sorts of information are also recorded as pre-pits.

As shown in FIG. 10, in a conventional one-layer type optical disk or one-layer hologram medium, address regions where address information is recorded and data regions where user data is recorded are alternately arranged. In this case, it is necessary to make the area ratio of the data regions larger and the area ratio of the address regions smaller so as to increase the recording capacity of the medium.

Moreover, in a two-layer type medium shown in FIG. 10, the address region and the data region can be positioned in separate layers and overlaid in a layer direction. Hence, when the area of the address region provided for one data region is small, the entire surface of the medium can be used as a recording region of user data, leading to higher format efficiency than that of the one-layer type medium, and thereby the recording capacity for the user data can be improved.

However, in the hologram recording medium, although user data can be multiplexed for recording so as to realize a large capacity, the area ratio of the address region and the area ratio of the data region are reversed. Thus, the area ratio of the address region is larger than the area ratio of the data region, thereby preventing realization of a further increase in volume of the user data.

Further, a beam spot size of a light beam for use in recording and reproduction is almost equivalent to the size of the minimum unit of data to be recorded. Also in reading address information, a beam spot of the same size is used.

FIG. 11 illustrates sizes of beam spots of a conventional optical disk and a hologram recording medium.

First, in the conventional optical disk, since the minimum unit of data to be recorded is one to several bits and the minimum unit of the address information is on the order of one bit, a beam spot having a diameter of the order of 0.4 μm, which is large enough to read one-bit data, is currently in use as a beam spot to be used for reproducing the information.

On the other hand, in a one-layer type hologram recording medium, although data information of the order of one mega bit can be recorded per page, a beam spot to be used therefor has a considerably large diameter of the order of 4 μm. Further, in this hologram recording medium, a beam having a diameter of the order of 4 μm is also used for reading the address information from the pre-pits. Accordingly, where the same volume of user data is to be recorded, the area of a region occupied with the user data is smaller in the hologram recording medium than in the conventional optical disk. However, the area of a region occupied with address information cannot be made smaller, and as a result, the area of the address region is relatively large.

Namely, in the hologram recording medium, there is a case where the area of the address region is larger than that of the data region as shown in FIG. 10. Similarly in a two-layer type medium, a recording capacity for user data cannot be increased since the address region occupies a large area of the medium.

Further, in the hologram recording medium, it may be considered to make a light beam to correspond to the minimum unit (one bit) of address information and to differentiate the size of a beam spot for use in recording and reproduction in the data region from the size of a beam spot for use in reading the address region.

However, in the present technique, the minimum size of a beam spot for reading address information is on the order of 0.4 μm, and address information in a unit smaller than this minimum size cannot be read.

For example, when the size of one side of one page of the hologram recording medium is made 200 μm and a plurality of pages are multiplexed as shown in FIG. 9, each of the multiplexed pages is assumed to have been shifted by 20 μm from the previous page. Herein, when the volume of data to be recorded per page is 100 Kbytes and the volume per sector is 2 Kbytes, one page consists of 50 sectors (2 Kbytes×50). In this case, it is necessary to write in the shifted region (20 μm×20 μm) address information of the data in one page (2 Kbytes×50) similarly in a one-layer type medium as well as a two-layer type medium.

For example, assuming that the number of bits required for recording address information per sector is 20, it is necessary to write address information of 50 sectors (20×50=1,000 bits) in the shifting width of 20 μm, and hence the size per bit needs to be 0.02 μm (=20 μm/1,000 bits) by simple calculation.

It is therefore necessary to use a beam spot for reproduction which is capable of reading pre-pit data having a diameter of about 0.02 μm in order to read address information of the hologram recording medium as described above.

As thus described, in the conventional hologram recording medium, although the recording density of user data itself can be improved to realize a large capacity, there is a problem that the recording density of an address region where address information for specifying a recording position of user data is recorded cannot be increased and the area of the address region thus is more dominant over the area of the data region as shown in FIG. 10, thereby hindering an increase in recording capacity of the medium as a whole.

### SUMMARY OF THE INVENTION

The present invention has been made in consideration of the foregoing circumstances, and an object of the present invention is to provide a hologram recording/reproducing device in which a configuration of physical addresses is devised to allow for reduction in the area occupied by an address region and improvement in recording capacity for user data.

The present invention provides a hologram recording/reproducing device for recording and reproducing information to/from a hologram recording medium adapted to multiplexing and recording of a plurality of page data, the plurality of page data being divided into a plurality of page groups, the plurality of page data in each page group being recorded in the same region, each page data being constituted of a plurality of recording unit regions, the medium comprising an address region and a recording region, the medium including a plurality of physical addresses each composed of a first physical address and a second physical address, the address region having fixedly recorded therein the first physical address in advance, each first physical address specifying each page group, each recording unit region of the recording region having recorded therein the second physical address and user data, each second physical address specifying each recording unit region, the recording/reproducing device comprising: a recording part; and a reproducing part, the recording part specifying the plurality of physical addresses to write user data into a specific physical address, the recording part writing the second physical address together with the user data in a specific recording unit region specified by the second physical address, the reproducing part reading page data recorded in a designated physical address.

With this configuration, it is possible to reduce the area for recording the physical address so as to increase the recording capacity for user data.

In the embodiments described below and FIGS. 1A to 1C, the address region corresponds to an address layer while the recording region corresponds to a recording layer.

The hologram recording/reproducing device may further comprise a reception part for receiving a logical address that specifies write-user data or read-user data, and an address conversion part for converting the received logical address into the physical address including a first physical address and a second physical address.

The present invention also provides a hologram recording/reproducing device, wherein a physical position of an address region, where the first physical address is fixedly recorded, is not identical to a physical position of a recording region where each piece of page data of a page group specified by the first physical address is multiplexed and recorded, when viewed in a direction perpendicular to a surface of the recording region.

Namely, the recording position of the first physical address is shifted from the recording position of the page group specified by the first physical address, thereby allowing reduction in process time for recording and reproduction.

The present invention also provides a recording method of a hologram recording/reproducing device, comprising the steps of: receiving user data and a logical address in which the user data is to be written; converting the received logical address into a first physical address and a second physical address which correspond to the logical address; producing write data which includes the user data and the second physical address; detecting a physical position on a hologram recording medium where a page group specified by the first physical address is to be recorded; and writing page data which includes the write data in the detected physical position such that the write data is among the page data included in the page group and is recorded in a recording unit region specified by the second physical address.

The present invention also provides a reproduction method of a hologram recording/reproducing device, comprising the steps of: receiving a logical address from which user data is to be read; converting the received logical address into a first physical address and a second physical address which correspond to the logical address; detecting a physical position on a hologram recording medium where a page group specified by the first physical address is to be recorded; and reading page data to which the user data belongs such that the user data is reproduced, the user data being among page data included in the page group recorded in the detected physical position and being recorded in a recording unit region specified by the second physical address.

The present invention also provides a hologram recording medium for executing data recording and data reproduction by means of the above hologram recording/reproducing device. Herein, the second physical address is written in each recording unit region where user data is recorded.

The hologram recording/reproducing device of the present invention comprises the recording part and the reproduction part. In order to record user data as a hologram in the medium and reproduce the user data recorded as the hologram, the device has a configuration for irradiating the medium with laser light and a configuration for detecting reflected light from the medium. Namely, the recording part and the reproduction part include an optical system comprising a light source, a collimator lens, a beam splitter, a prism, an objective lens, a lens actuator, a photodetector, an optical spatial modulator, a beam expander, a relay lens, a wavelength plate, and a phase modulator.

Further, the hologram recording/reproducing device of the present invention has a communication function block for receiving a write request or a read request from a host device such as a personal computer and transmitting information of a recording or reproduction result to the personal computer or the like.

The communication function block includes a transmission part, a reception part, address conversion part and the like. The function of each part is realized by a microcomputer comprising a CPU, a ROM, a RAM, an I/O interface and the like, and a DSP. Further, a variety of processes to be performed in recording and reproduction can be realized by activating hardware requiring a CPU, based upon control programs stored in the ROM and the like.

According to the present invention, the physical address of the medium is divided into two addresses: the first physical address for specifying the page group which is fixedly recorded in the address layer and the second physical address for specifying the record unit region which is recorded in the recording layer. Therefore, it is possible to make the area of the region where the address information is recorded smaller than in the conventional case, so as to increase the recording capacity for user data to be recorded in the medium.

### BRIEF DESCRIPTION OF THE DRAWINGS

FIGS. 1A to 1C are views illustrating the construction of a hologram recording medium according to an embodiment the present invention;

FIGS. 2A to 2C are schematic views illustrating the configuration of a recording/reproducing device and a reproducing operation of a recording/reproducing medium according to the present invention;

FIG. 3 illustrates a physical address for use in the present invention;

FIG. 4 illustrates a relationship among a page group, page data and sectors according to the present invention;

FIG. 5 illustrates a specific example of a method for allocating a physical address of the recording medium according to the present invention;

FIG. 6 is a flowchart of a data recording process of the recording/reproducing device according to the present invention;

FIG. 7 is a flowchart of a data reproducing process of the recording/reproducing device according to the present invention;

FIG. 8 illustrates a recording structure of a conventional optical disk;

FIG. 9 illustrates a recording structure of a conventional hologram recording medium;

FIG. 10 illustrates recording structures of the conventional optical disk and hologram medium; and

FIG. 11 illustrates sizes of data information and address information of the conventional optical disk and hologram medium.

### DETAILED DESCRIPTION OF THE PREFERRED EMBODIMENTS

In the following, the present invention will be specifically described based upon embodiments shown in the drawings, but is not limited thereto.

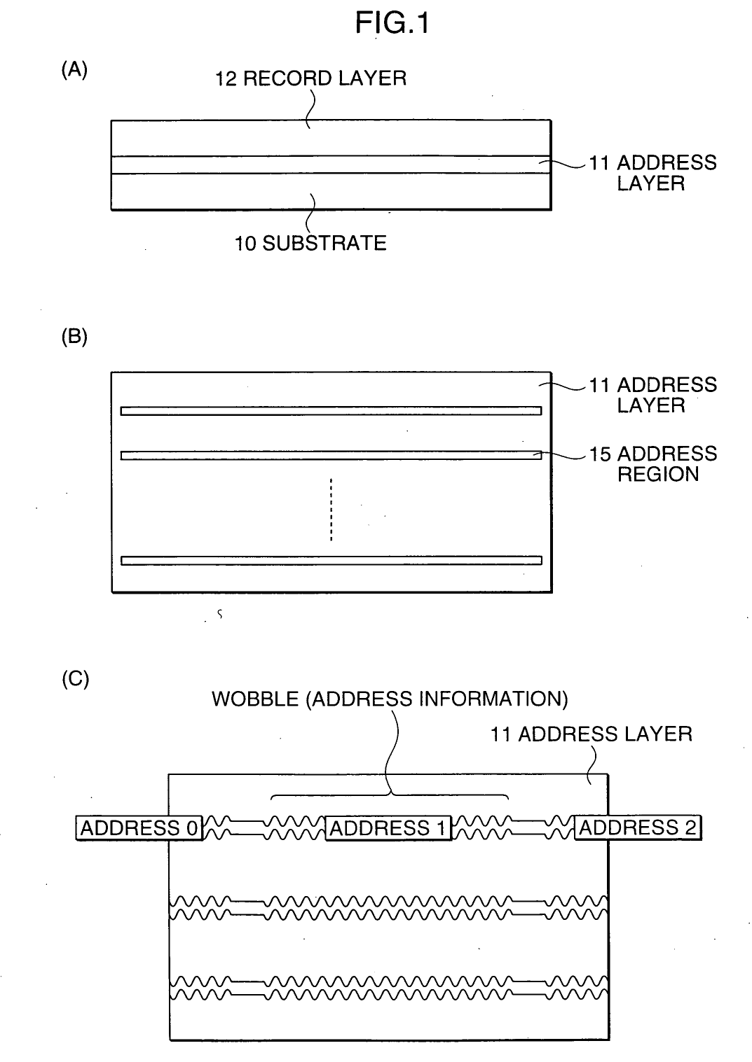

FIGS. 1A to 1C are views illustrating the construction of a hologram recording medium according to an embodiment the present invention.

FIG. 1A is a sectional view of the medium. The hologram recording medium of the present invention has a lamination structure of at least an address layer 11 and a recording layer 12 on a substrate 10. For recording or reproduction, the surface of the recording layer 12 is irradiated with recording or reproduction laser light. The boundary between the substrate 10 and the address layer 11 serves as a reflection face to reflect the laser light. The radiated laser light is reflected by the reflection face to be emitted upward from the recording layer 12, and the emitted light is detected to reproduce address information and user data.

The address layer 11 is a layer where address information has been fixedly recorded in advance, using, for example, a pit pattern physically formed of projections and depressions or a wobble pattern formed by meandering of a wall face in a set period.

FIG. 1B is a plan view of the medium seen from the top, representing, as one embodiment, a state in which several address regions 15, where address information is recorded, are formed in one direction in the address layer 11.

FIG. 1C shows an example of forming address information in the wobble pattern. One address (e.g., Address 1) is specified by one wobble pattern having a set length. One address fixedly recorded in the address layer 11 corresponds to the under-mentioned first physical address (PA1), and is an address for specifying a page group.

The page group is a generic name for a plurality of pages to be multiplexed and recorded in one recording region. One first physical address (PA1) is given to one page group. For example, when page data consisting of 10 pages is multiplexed and recorded in the same region, 10 pages constitutes one page group, and the respective first physical addresses for those 10 pieces of page data are identical.

The recording layer 12 is a layer where user data is multiplexed and recorded in a page unit, and as described below, a second physical address (PA2) is also recorded.

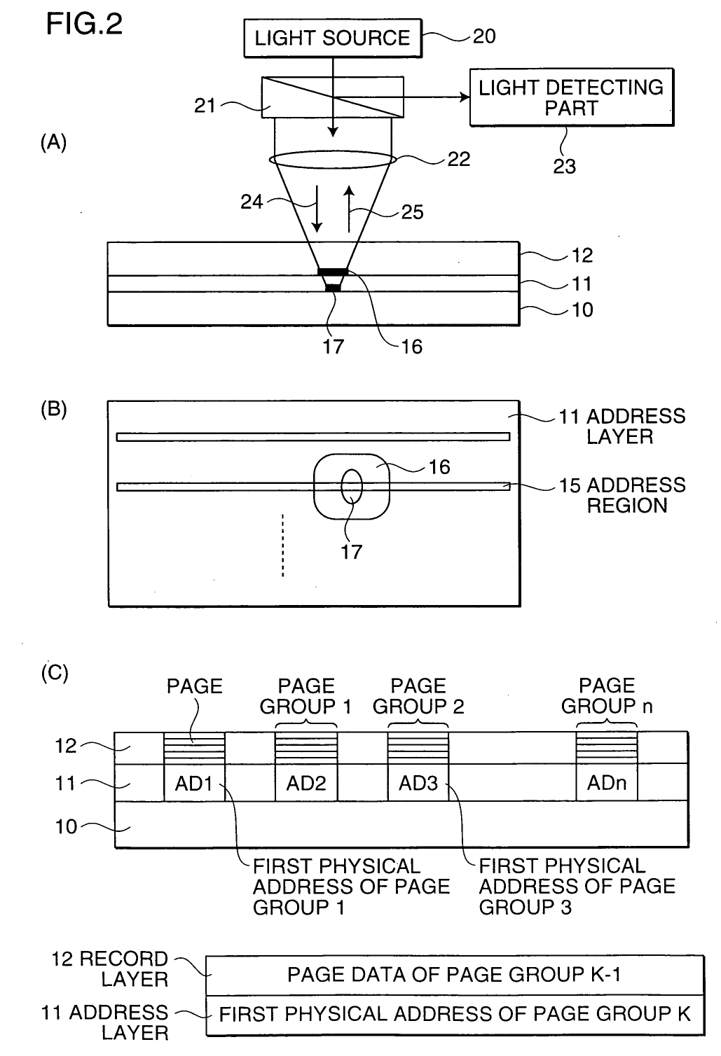

FIGS. 2A to 2C schematically illustrate the configuration of a hologram recording/reproducing device for recording and reproducing data in/from the hologram recording medium of the present invention. Here, illustrated is a case where the medium having data already recorded therein is reproduced.

As shown in FIG. 2A, the hologram recording/reproducing device mainly comprises a light source 20, a beam splitter 21 for splitting laser light, an objective lens 22, and a photodetector 23.

The recording layer 12 and the address layer 11 are irradiated through the objective lens 22 with laser light 24 emitted from the light source 20. The light is reflected by the reflection face, and then transmitted upward as reproduction light 25 including address information 17 and user data 16, to be detected by the photodetector 23. At this time, as shown in FIG. 2B, the area of a region 17 of the laser light with which the address layer 11 is irradiated is smaller than that of a region 16 of the laser light with which the recording layer 12 is irradiated.

Two-dimensional user data included in the region 16 of the recording layer 12 is detected by the photodetector 23 for reproduction. Among pieces of multiplexed and recorded page data constituting a page group included in this region 16, only one page is selected by the radiated laser light, and only this selected page data is reproduced. On the other hand, as an address, the first physical address (PA1) recorded in the region 17 is reproduced.

FIG. 2C schematically illustrates a positional relationship between the first physical address and the recorded page data. Herein, the first physical address PA1 is expressed by AD1, AD2, . . . ADₙ₊₁.

Above each region where one first physical address (AD1, AD2, . . . ADn) is recorded, pieces of multiplexed page data are recorded, and those pieces of multiplexed page data constitute one page group (1, 2, . . . n), and each page group is specified by a first physical address (PA1).

FIG. 2C shows a case where a physical recording position of a first physical address is shifted by one address from a physical recording position of a page group specified by the first physical address. Namely, the recording position of the first physical address in the address layer and the recording position of the page group specified by the first physical address in the recording layer are arranged so as not to be in the same region when viewed in the direction perpendicular to the surface of the recording layer. For example, the first physical address AD1 is an address for specifying a page group 1 recorded above the first physical address AD2, and the first physical address AD2 is an address for specifying a page group 2 recorded above the first physical address AD3 next to the first physical address AD2.

As thus described, the recording position of the first physical address PA1 is shifted from the recording position of the page group specified by the address so that immediately after reproduction of the first physical address, data of a page group corresponding to the reproduced address can be written, thereby allowing reduction in process time for recording and reproduction. However, the recording position of the first physical address and the recording position of the page data of the page group specified by the address may be in the same region when viewed in a vertical direction.

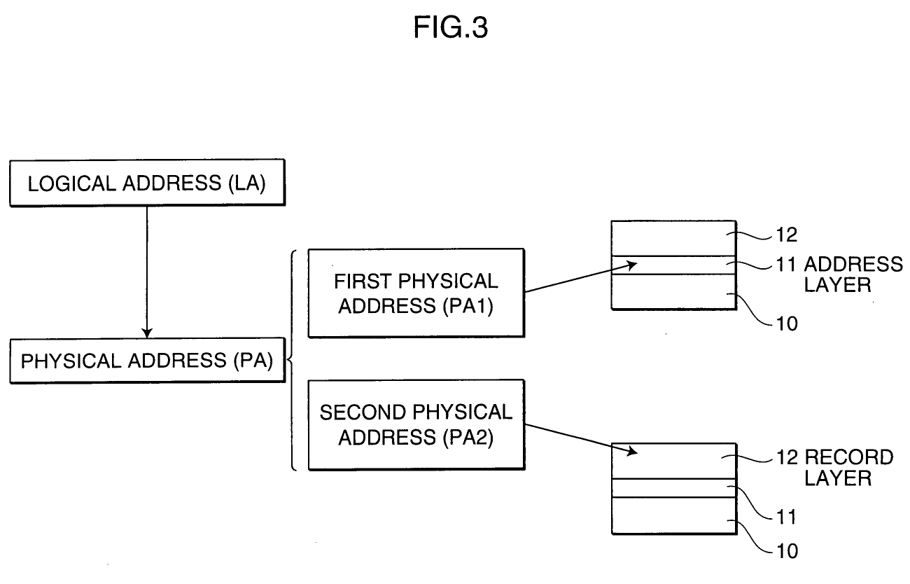

FIG. 3 illustrates the configuration of a physical address for use in the present invention.

A physical address (hereinafter referred to as “PA”) is information for specifying a region (hereinafter referred to as “sector”) in the minimum unit to be recorded on the medium.

For example, when the physical address PA=100 is designated as a reproduction address, a group of data recorded in a sector given in advance the address “100” is read.

The present invention is characterized in that the physical address PA is split into addresses written in different manners for management. For example, the physical address PA is split into two sorts of information for management: pre-pit type information written in advance in the recording medium; and data information of a hologram to which additional information is writable.

As shown in FIG. 3, one of the two sorts of information is a first physical address (PA1) to be fixedly recorded in the address layer 11, which is used as an address for specifying a page group.

The other one is a second physical address (PA2) to be recorded in the recording layer 12, which is used as an address for specifying a sector. This address is not information that is fixedly recorded in advance, but is information that is written in a specific region of the recording layer 12 at the time of recording user data in the same manner as writing of the user data. Namely, one physical address PA is specified by two sorts of address information PA1 and PA2.

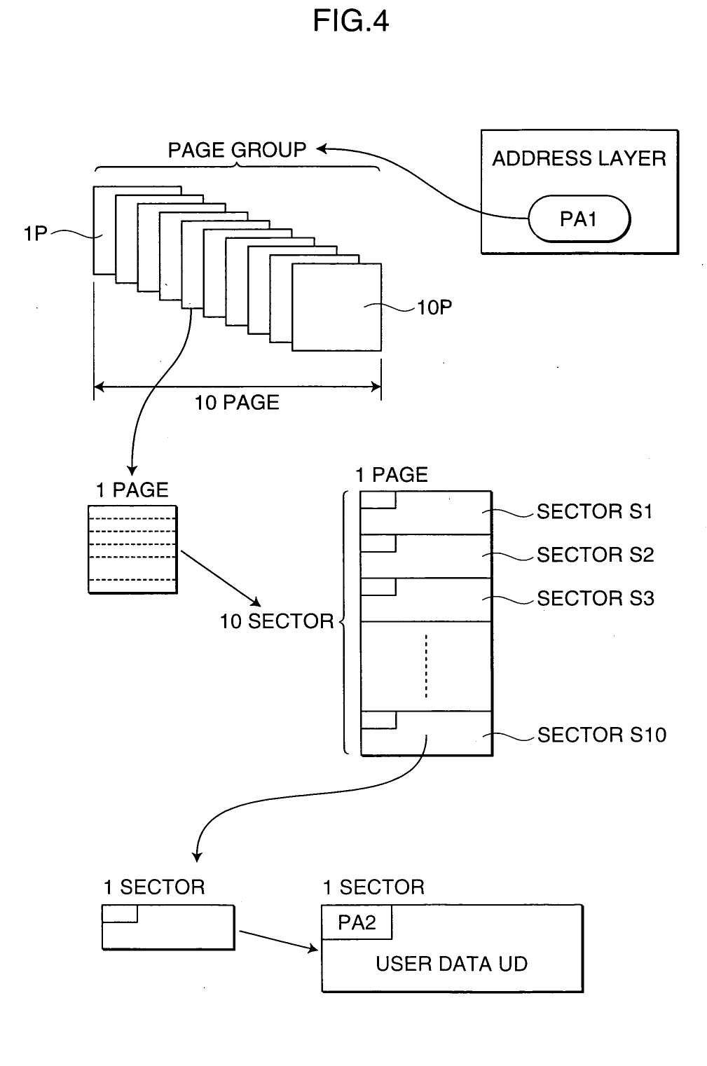

FIG. 4 illustrates a relationship among a page group, page data and sectors according to the present invention. Here, for the sake of simplifying the description, it is assumed that one page group consists of page data of 10 pages, and one piece of the page data consists of 10 sectors. However, in a medium for use in reality, such a numerical relationship is not fixed, but a suitable numerical relationship is selected according to design and the like.

First, one page group is specified by the first physical address PA1 recorded in the address layer 11, and page data of 10 pages is recorded in the same recording region of the first physical address PA1. Namely, the same first physical addresses PA1 have been given to 10 pieces of page data. One piece of page data is divided into sectors as minimum recording unit regions of the data. Here, one piece of page data consists of 10 sectors (S1, . . . S10).

User data (UD) is recorded in one sector and, in the present invention, the second physical address (PA2) is also recorded therein. Namely, the information (PA2) for specifying a sector is recorded in each sector.

For example, assuming that one sector is a region capable of recording 2,000-byte data, only 4-bit information may be used for differentiating 10 sectors. This means that only four bits among 2,000 bytes are used for the second physical address. Here, the remaining region after subtraction of four bits from 2,000 bytes serves as a region usable for recording user data. Since the region for recording the user data is reduced only by four bits, there is no significant effect on the recording capacity of the user data.

For example, even if one page data consists of several thousand sectors, the effect on the recording capacity for user data to be recorded is small since the number of bits used for the second physical address is 10 at the highest.

On the other hand, assuming that one page group consists of page data of 10 pages, the first physical address PA1 for specifying the page group can be expressed for example by information of the order of 20 bits. Since the width of the part of the address layer in which this address PA1 is fixedly recorded may be on the order of 40 μm (2 μm/bit×20 bits), the width can be made sufficiently smaller than the width (e.g., the order of 200 μm (20 μm/shift×10 shifts)) of page data to be recorded above the address layer. Accordingly, it can be said that the recording region of the address PA1 cannot be a determinant of the recording capacity of the entire medium, and the recording capacity can be determined by the data recording area of a page group where user data is recorded. In other words, in the present invention, the recording capacity of the user data can be determined by the recording area of the recording layer, as shown in FIG. 2C, and it is thereby possible to make so-called format efficiency close to 100%.

Moreover, the second physical addresses PA2 to be recorded in the respective sectors may provide inherent and different information within one page group, and may provide the same sort of information when belonging to different page groups.

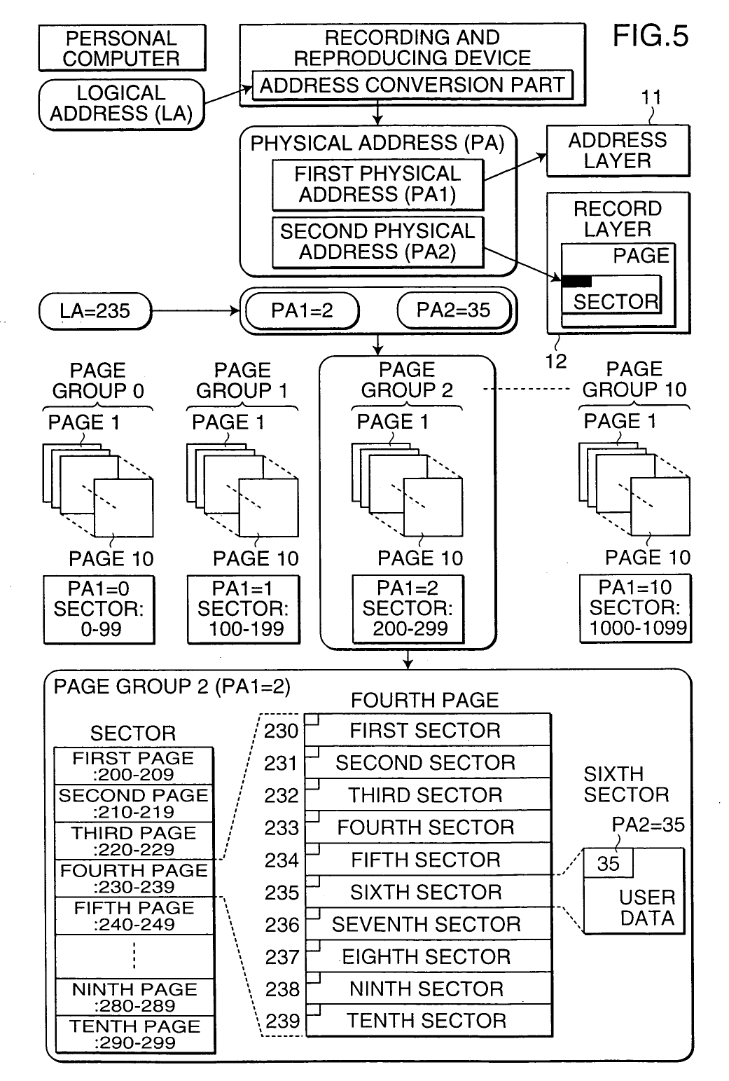

FIG. 5 illustrates a specific example of a method for allocating a physical address according to the present invention. The physical addresses and numerical values of sectors shown in FIG. 5 are only an example and the numerical values for use in an actual medium should not be limited thereto.

The hologram recording medium of the present invention is installed in an exclusive recording/reproducing device. Upon receipt of a read instruction or a write instruction from a personal computer PC or the like connected to the recording/reproducing device, data having been written in the medium is read or new data is written in. Such data communication between the recording/reproducing device and the personal computer or the like can be realized by almost the same process as the process for data communication between a personal computer and a currently used recording/reproducing device for as a CD, a DVD or the like.

In transmission of an instruction to read or write data from the personal computer PC, a “logical address (LA)” is designated for specifying a read position or a write position on the medium. The logical address LA is information for specifying a recording position on the medium when viewed from the personal computer PC side. Since the logical address LA differs from the physical address PA actually given in the medium, a process for converting the logical address LA into the physical address PA, or a reverse process for converting the physical address PA into the logical address LA, is performed in the recording/reproducing device. Such address conversion processes are performed by control programs stored in advance in a ROM or the like of the recording/reproducing device.

Although the address conversion process can be performed by the predefined four basic operations of arithmetic, the operations cannot be expressed by one equation as being different depending on the design (e.g., the number of multiplexed pages, the number of sectors per page, etc.) of the medium, performance of the recording/reproducing device, or the like.

Numerical values and details of a conversion process of a method for allocating an address which are described below are just an example, and not limitative.

In the present invention, a logical address (LA) given by the personal computer is converted into two physical addresses (PA1, PA2) by an address conversion process. Namely, the logical address LA is converted into a first physical address PA1 for specifying a page group, and a second physical address PA2 for specifying a sector present in the page group.

In FIG. 5, assuming that a read instruction to “read data recorded in a sector whose logical address LA is 235” is transmitted from the personal computer PC to the recording/reproducing device, the address conversion part of the recording/reproducing device produces a first physical address PA1=2 and a second physical address PA2=35 from the logical address LA=235. As a precondition for performing such address conversion, it is assumed that the configuration of the physical addresses of the medium is predetermined as shown in FIG. 5.

It is assumed that the first physical addresses (PA1) of consecutive integers such as 0, 1, 2, . . . are allocated to the page groups. Here, it is assumed that one page group consists of page data of 10 pages, one piece of the page data consists of 10 sectors, and each sector number is given in order from the top of sector of the first page.

For example, a page group 2 is given 2 as the first physical address PA1, and 10 sectors in the first page of this page group are respectively given address numbers 200 to 209 for specifying each sector.

Similarly, 10 sectors in the second page of this page group are respectively given address numbers 210 to 219, 10 sectors in the third page are respectively given address numbers 220 to 229, and 10 sectors in the fourth page are respectively given address numbers 230 to 239.

Here, looking at the fourth page, the sector number of the first sector is 230, and serial numbers from 230 are given to the subsequent sectors. Hence the sector number of the sixth sector is 235, and the sector number of the final tenth sector is 239.

In this embodiment, lower two digits (00 to 99) of an address for specifying a sector correspond to the second physical address PA2. Further, the physical address PA1=2 is information fixedly recorded in the address layer 11, whereas the second physical address PA2=35 is information written as hologram data in the recording layer 12 in the same manner as writing of user data.

For example, the second physical address PA2 is written into a region of top several-bit of each sector. In the case of PA2=35, the numerical value 35 is written in the sixth sector of the fourth page.

This second physical address PA2 is not yet recorded in each sector of the medium when it is manufactured. When a first write instruction is transmitted from the personal computer PC to one sector, the second physical address PA2 is written in the sector together with user data.

Further, in an initial medium which is at the stage after the manufacturing thereof and in which no data has been written, no second physical address has been written either. Therefore, even when this initial medium receives an instruction to read data, it will only result in an error.

The above description is a specific example of a method for allocating the physical address PA according to the present invention.

As thus described, since the physical address PA is divided into two addresses: the one (PA1) used as a fixedly recorded address for specifying a page group; and the other (PA2) used as a hologram-recorded address for specifying a sector which is the minimum recording unit region for recording user data, it is possible to reduce the information volume of the addresses fixedly recorded in the address layer. This allows reduction in area of a region used for recording address information, and thereby the address information is not a determinant for the storage capacity of the medium.

Further, since the information volume of the second physical addresses that are hologram-recorded is very small as compared with the information volume of user data which is also hologram-recorded, the information volume of the second physical addresses is hardly a factor for reducing the recording capacity of the user data.

Moreover, since the area of the recording region of the user data to be recorded in the recording layer of the hologram recording medium is a determinant of the storage capacity of the medium whereas the address information is hardly a determinant of the same, it is possible to enhance the format efficiency of the medium and thereby to increase the storage capacity of the medium as a whole.

Next, embodiments of a recording process and a reproduction process of the recording/reproducing device according to the present invention will be described.

Recording Process

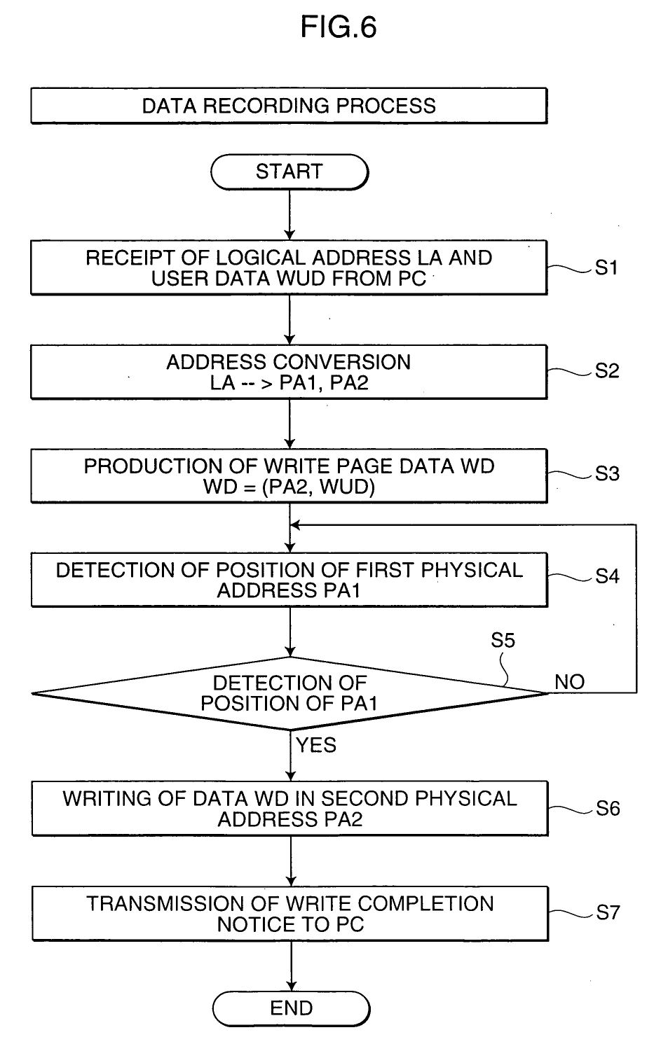

FIG. 6 is a flowchart of a recording process of the recording/reproducing device according to an embodiment of the present invention.

First, in step S1, the recording/reproducing device receives a request for writing data from the personal computer PC, and receives a logical address LA included in the request and user data WUD. In order to record the received user data WUD in a physical position of the medium which corresponds to the logical address LA, the following process is performed.

In step S2, the address is converted. Here, a predetermined calculation is performed for converting the received logical address LA, so that a first physical address PA1 and a second physical address PA2 are generated. This conversion leads to determination of a physical position where the user data is to be written. Namely, a page group, a page and a sector, in which the user data is to be written, are specified.

In step S3, page data WD to be written is produced. The page data WD includes data converted from the user data WUD into a writing format by encoding, and the second physical address PA2 specifying an address of a sector in which the data is to be written.

In step S4, the physical position on the medium of the page group, where the produced first physical address PA1 has been allocated, is detected. Since this first physical address PA1 has been fixedly recorded in the address layer 11 of the medium, a record pattern (pit or wobble) corresponding to PA1 is searched.

In step S5, the process of step S4 is repeated until an agreement between a target address and the first physical address PA1 is confirmed and it is ready for recording beam light to be radiated to the position of the first physical address PA1.

When the position of the first physical address PA1 is detected in step S5, the process proceeds to step S6, and recording beam light for writing the page data WD is radiated such that the user data WUD is written in a position of a sector corresponding to the second physical address PA2. Here, the second physical address PA2 and data corresponding to the user data WUD are written in the sector specified by the second physical address PA2.

In step S7, a writing completion notice is transmitted to the personal computer PC, and the recording process is completed.

Reproduction Process

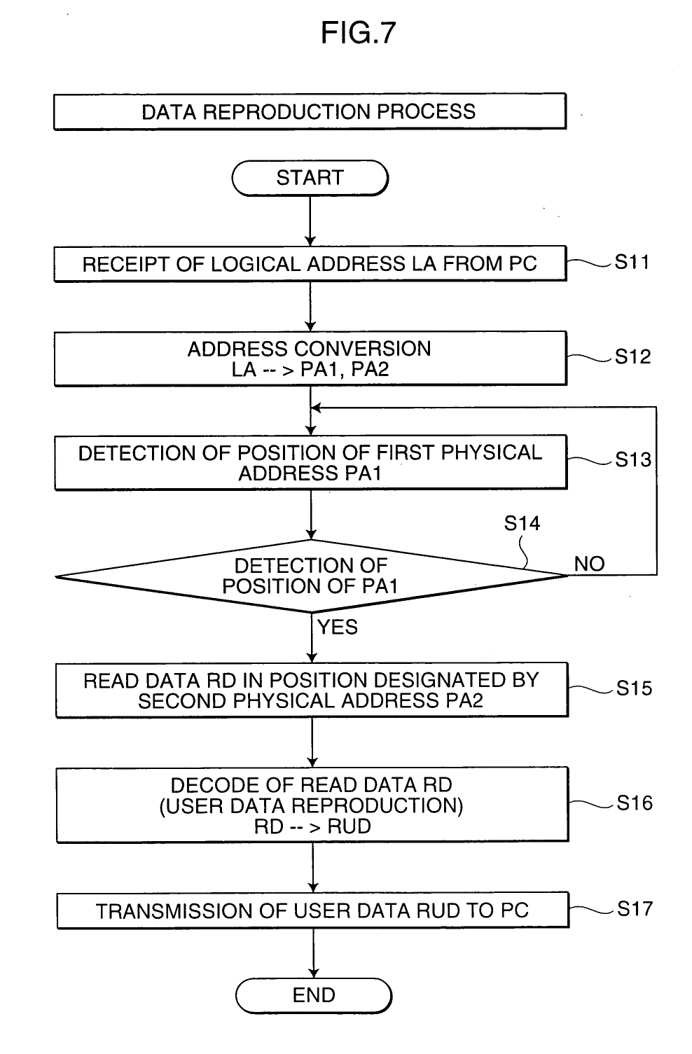

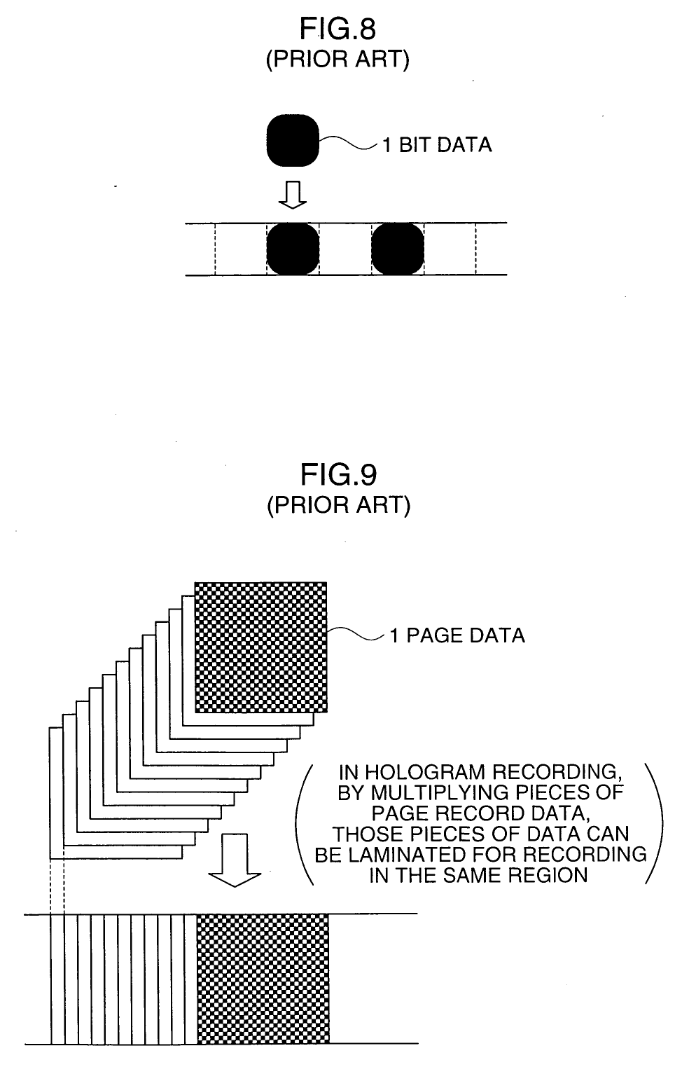

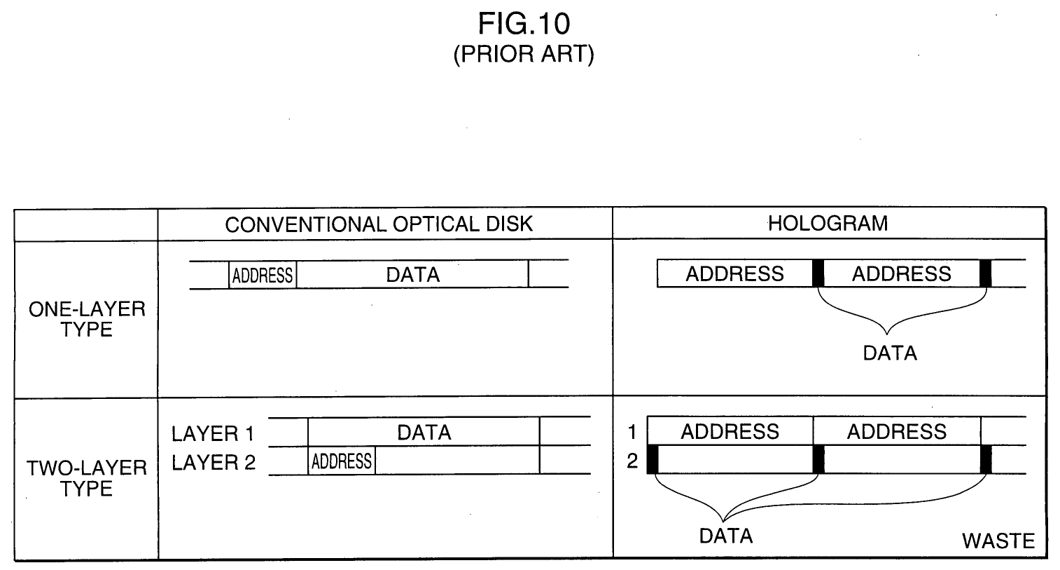

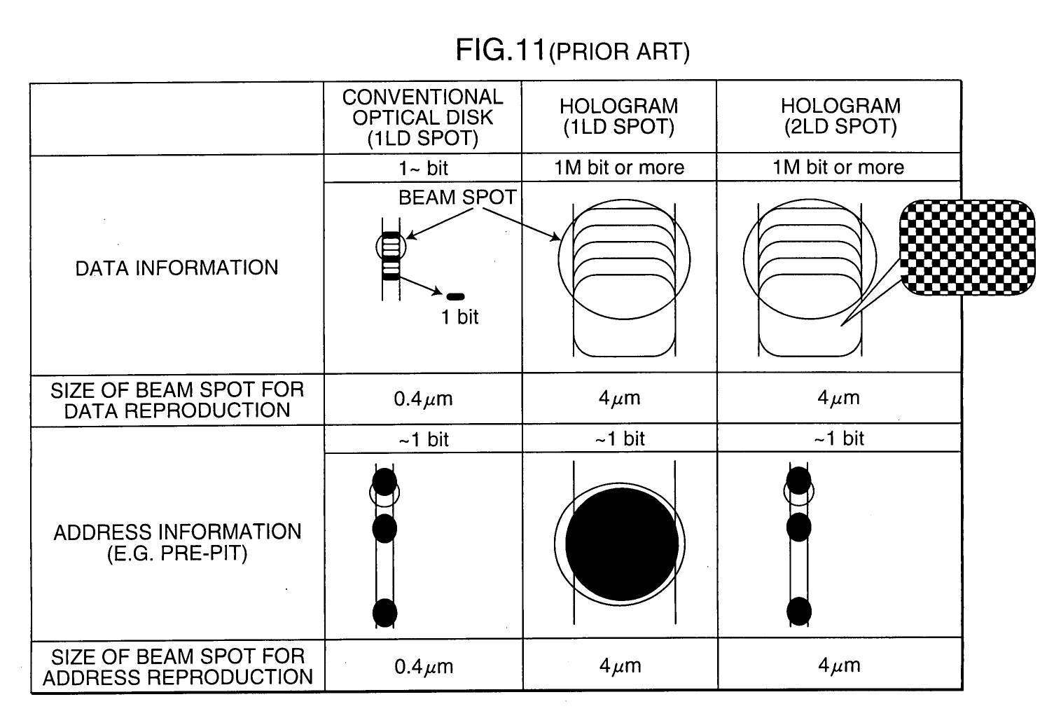

FIG. 7 is a flowchart of a reproduction process of the recording/reproducing device according to an embodiment of the present invention.

First, in step S11, the recording/reproducing device receives a request for reading data from the personal computer PC, and receives a logical address LA included in the request.

In step S12, the address is converted. Here, a predetermined calculation is performed for converting the logical address LA, so that a first physical address PA1 and a second physical address PA2 are generated.

In step S13, the physical position on the medium of the page group which is specified by the generated first physical address PA1 is detected. The process in step S13 is repeated while sequentially checking pieces of address information fixedly recorded in the address layer of the medium, until it is ready for reproducing beam light to be radiated to the position of the first physical address PA1 in step S14.

In step S14, when the first physical address PA1 is detected, the process proceeds to step S15, and data RD recorded in the sector corresponding to a position designated by the second physical address PA2 is read. Here, pieces of page data of the page group specified by the first physical address PA1 are sequentially read to be temporarily stored, and then the second physical address PA2 already recorded in each sector in the page data is acquired. A process for comparing the acquired second physical address PA2 with the second physical address PA2 obtained in step S12 is performed. In this comparison, when the two second physical addresses do not agree with each other, a next sector is checked, and when the two addresses agree with each other, data in the sector of the agreed addresses is read.

In step S16, the read data RD is decoded to generate user data URD.

In step S17, the generated user data RUD is transmitted to the personal computer PC, and the reproduction process is completed.

The reproduction process is described below using the specific example shown in FIG. 5. First, from the logical address LA=235 given by the personal computer PC, the first physical address PA1=2 and the second physical address PA2=35 are calculated (step S12). This indicates that data to be reproduced is positioned in the sixth sector of the fourth page in the page group 2. Therefore, the address information fixedly recorded in the address layer of the medium is checked to detect the position of the page group 2 to be reproduced (step S13). Beam light is radiated so as to reproduce the fourth page, and the reflected reproduction light is detected. When the detected reproduction light is decoded, all page data of the fourth page is obtained. Then the predetermined second physical addresses recorded in the respective sectors are sequentially checked, thereby detecting the position of the sixth sector that corresponds to desired “PA2=35”. User data RUD recorded in that position is acquired (steps S15, S16), and then transmitted to the personal computer PC (step 17).

It should be noted that, although the second physical address is given to each sector in the foregoing embodiment, an index indicating a second physical address may be given to the top of each page. This configuration enables reduction in time required for determining whether a page, from which data is to be read or in which data is to be written, is a desired page specified by the address. Further, the second physical addresses PA2 to be recorded in the respective sectors may provide inherent and different information in one page.

Moreover, there may be cases where one first physical address corresponds to a plurality of second physical addresses. For example, a second physical addresses corresponding to one first physical address may include an address for specifying a page and an address for specifying a sector.

What is claimed is:

1. A hologram recording/reproducing device for recording and reproducing information to/from a hologram recording medium adapted to multiplexing and recording of a plurality of page data, the plurality of page data being divided into a plurality of page groups, the plurality of page data in each page group being recorded in the same region, each page data being constituted of a plurality of recording unit regions,
the medium comprising an address region and a recording region, the medium including a plurality of physical addresses each composed of a first physical address and a second physical address, the address region having fixedly recorded therein the first physical address in advance, each first physical address specifying each page group, each recording unit region of the recording region having recorded therein the second physical address and user data, each second physical address specifying each recording unit region,
the recording/reproducing device comprising:
a recording part; and
a reproducing part,
the recording part specifying the plurality of physical addresses to write user data into a specific physical address, the recording part writing the second physical address together with the user data in a specific recording unit region specified by the second physical address,
the reproducing part reading page data recorded in a designated physical address.

2. The hologram recording/reproducing device according to claim 1, further comprising:
a reception part for receiving a plurality of logical addresses that specify write-user data and/or read-user data; and
an address conversion part for converting the received logical addresses into the physical addresses each composed of the first physical address and the second physical address.

3. The hologram recording/reproducing device according to claim 1, wherein a physical position where a specific first physical address is fixedly recorded in the address region is not identical to a physical position where page data of a page group specified by the first physical address is multiplexed and recorded in the recording region when viewed in a direction perpendicular to a surface of the recording region.

4. A recording method of a hologram recording/reproducing device, comprising the steps of:
receiving user data and a logical address in which the user data is to be written;
converting the received logical address into a first physical address and a second physical address which correspond to the logical address;
producing write data which includes the user data and the second physical address;
detecting a physical position on a hologram recording medium where a page group specified by the first physical address is to be recorded; and
writing page data which includes the write data in the detected physical position such that the write data is among the page data included in the page group and is recorded in a recording unit region specified by the second physical address.

5. A reproduction method of a hologram recording/reproducing device, comprising the steps of:
receiving a logical address from which user data is to be read;
converting the received logical address into a first physical address and a second physical address which correspond to the logical address;
detecting a physical position on a hologram recording medium where a page group specified by the first physical address is to be recorded; and
reading page data to which the user data belongs such that the user data is reproduced, the user data being among page data included in the page group recorded in the detected physical position and being recorded in a recording unit region specified by the second physical address, is reproduced.

6. A hologram recording medium for executing data recording and data reproduction by means of the hologram recording/reproducing device according to claim 1, wherein the second physical address is written in each recording unit region where user data is recorded.
